(19) United States
(12) Patent Application Publication
(10) Pub. No.: US 2026/0163915 A1
(43) Pub. Date: Jun. 11, 2026

(54) Machine Learning-Based System for Dynamic Decoy Data Generation

(71) Applicant: Bank of America Corporation, Charlotte, NC (US)

(72) Inventors: Adam King, Fort Mill, SC (US); Sanjay Lohar, Mint Hill, NC (US); Matthew K. Bryant, Mount Holly, NC (US); Peter Nein, Waxhaw, NC (US); Natalie Sterling, Fort Mill, SC (US); Cara Bresnahan, Chicago, IL (US); Elizabeth Swanzy-Parker, Charlotte, NC (US)

(21) Appl. No.: 18/971,948

(22) Filed: Dec. 6, 2024

(51) Int. Cl. H04L 9/40

(52) U.S. Cl. CPC H04L 63/1491

(57) ABSTRACT

Arrangements for using machine learning to generate decoy data are provided. In some examples, a computing platform may receive a request to access data from a user device. Upon determining that the user device is associated with a threat actor, the computing platform may generate, using a generative artificial intelligence model, decoy first data based. The decoy first data may be provided to the threat actor via the user device. User input requesting access to additional data may be received from the user device of the threat actor and used to generate, via the generative artificial intelligence model, additional decoy data that may also be provided to the threat actor. Accordingly, the threat actor may remain engaged with the computing platform and the computing platform may capture characteristics of the threat actor that may be used to develop and deploy countermeasures.

### BACKGROUND

Aspects of the disclosure relate to electrical computers, systems, and devices for using machine learning to dynamically generating decoy data.

Current cybersecurity systems include arrangements for preventing threat actors or unauthorized users from accessing the system. However, once the threat actor has accessed the system, the threat actor may access a variety of data until the breach is detected and/or mitigated. This may lead to loss of confidential, personal or other information. While some conventional systems include static honeypot arrangements, sophisticated threat actors can quickly identify those arrangements and may then terminate the session. Accordingly, it would be advantageous to provide a dynamic system that continuously generates decoy data to keep threat actors engaged while capturing characteristics or features of the threat actor and/or associated devices.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with maintaining data security while capturing threat actor characteristics.

In some examples, a computing platform may receive a request to access data. In some examples, the request to access data may include first data associated with the request, such as a file name, directory name, or the like. Upon determining that the user device requesting the access is associated with a threat actor, the computing platform may generate, using a generative artificial intelligence (AI) model, decoy first data based on the first data associated with the request. The decoy first data may be provided to the threat actor via a user device of the threat actor. User input requesting access to additional data may be received from the user device of the threat actor and used to generate, via the generative AI model, additional decoy data. Accordingly, the threat actor may remain engaged with the computing platform and the computing platform may capture characteristics of the threat actor that may be used to develop and deploy countermeasures.

In some examples, a request for data may include a database query. The computing platform may intercept the database query at the parsing layer and may generate, using the AI model, decoy database query response data that may be provided to the threat actor.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for using machine learning to generate decoy data in accordance with one or more aspects described herein;

FIGS. 2A-2E depict an illustrative event sequence for using machine learning to generate decoy data in accordance with one or more aspects described herein;

FIG. 3 illustrates an illustrative method for using machine learning to generate decoy data according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional arrangements rely on static honeypot arrangements to mislead threat actors during a cyber attack. However, sophisticated threat actors can quickly identify these arrangements and may terminate a session before intelligence related to the threat actor can be captured.

Accordingly, the arrangements described herein provide a dynamic, machine learning-based system for generating, in real-time, decoy data that appears legitimate to the threat actor and encourages the threat actor to continue exploring, while capturing intelligence related to the threat actor that can be used to develop and deploy countermeasures.

In some examples, a generative AI model may be used to generate, in real-time, decoy data based on features related to selections or requests by the threat actor. For instance, a file name of a first file requested may be used to generate additional decoy files, decoy content or the like, that may be presented to the threat actor for selection. The AI model may be trained using historical data of the enterprise organization in order to ensure that naming convention, file structures, and the like, of the generated decoy data are consistent with legitimate enterprise organization data.

These and various other arrangements will be discussed more fully below.

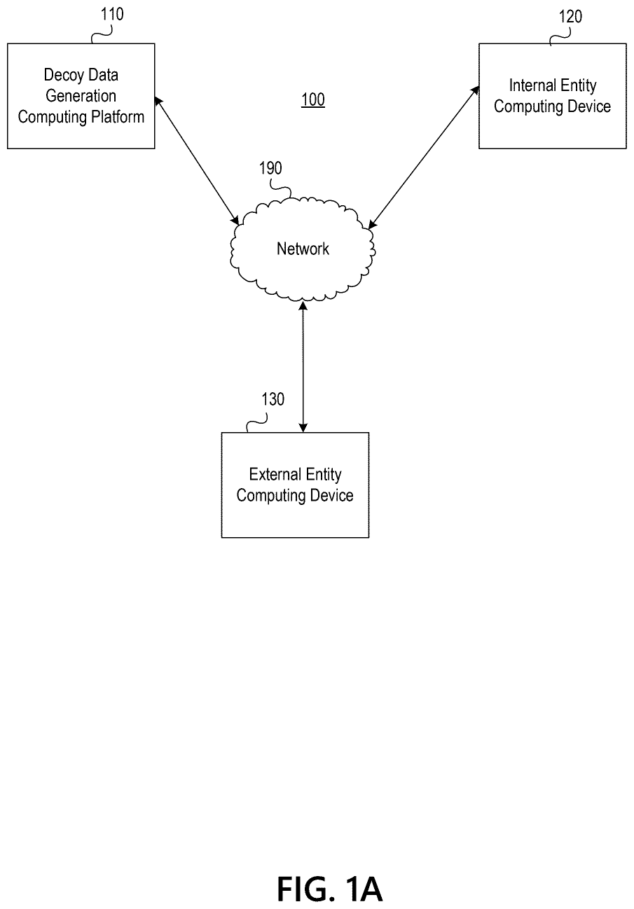

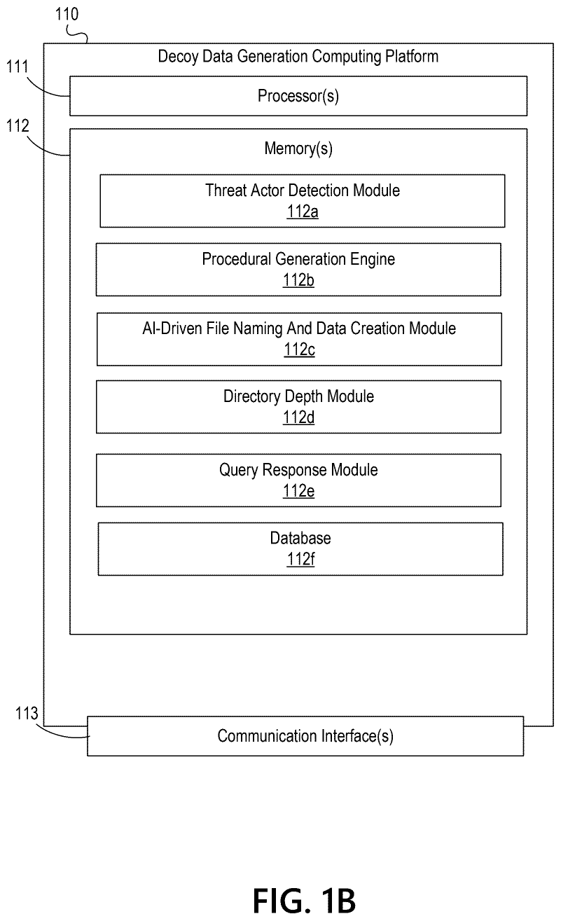

FIGS. 1A-1B depict an illustrative computing environment and devices for decoy data generation in accordance with one or more aspects described herein. Referring to FIG. 1A, computing environment 100 may include one or more computing devices and/or other computing systems. For example, computing environment 100 may include decoy data generation computing platform 110, internal entity computing device 120, and external entity computing device 130.

Although one internal entity computing device 120 and one external entity computing device 130 is shown, any number of systems or devices may be used without departing from the invention.

Decoy data generation computing platform 110 may be or include one or more computer components (e.g., servers, server blade, processor, memory, and the like) and may be configured to perform intelligent, dynamic, decoy data generation functions. For instance, decoy data generation computing platform 110 may detect an unauthorized user or threat actor computing device, such as external entity computing device 130. The threat actor may be detected based on previous experience with the threat actor or associated device, based on behavioral data, or the like. Upon detecting the unauthorized user or threat actor, one or more decoy data generation processes may be activated.

In some examples, decoy data generation computing platform 110 may identify a first file name, file type, content type, or the like, associated with a data request from the threat actor computing device (e.g., external entity computing device 130). Based on the data from the data request, a generative artificial intelligence model may be executed to output or generate a second or subsequent decoy file name, file type, content, or the like, and may provide access to the decoy file name, file type, content or the like. This may appear, to the threat actor, that they are accessing actual enterprise data, while the enterprise is able to capture characteristics of the threat actor, device 130, or the like. The subsequent selections made by the threat actor via external entity computing device 130 may be captured and processed, using the generative artificial intelligence model, to output additional decoy file names, file structures, content or the like.

In some examples, the threat actor may submit a data query. The query may be received by decoy data generation computing platform 110 and may be input to the generative artificial intelligence model to output or generate decoy query results that may appear authentic (e.g., based on generation from the generative artificial intelligence model) but do not expose any actual authentic enterprise data. The threat actor may seem to be obtaining enterprise data while the decoy data generation computing platform 110 may continue to capture characteristics or aspects of the threat actor, external entity computing device 130, or the like.

The process of created decoy data, file structures, and the like may continue as long as the threat actor continues to request data (e.g., via the external entity computing device 130). The decoy data generation computing platform 110 may continue to capture threat actor data which may then be transferred to, for instance, internal entity computing device 120, for analysis, execution of mitigation actions, or the like.

In some examples, the data associated with the threat actor and captured by the decoy data generation computing platform 110 may be transmitted or sent to an internal entity computing device, such as internal entity computing device 120, for analysis, use in executing one or more mitigation actions, and the like.

Internal entity computing device 120 may be or include one or more computing devices (e.g., laptop computers, desktop computers, mobile devices, tablet devices, or the like) that may be used by an employee, agent, associate or other user of the enterprise organization implementing the decoy data generation computing platform 110. In some examples, internal entity computing device 120 may receive threat actor data, analyze the threat actor data, identify and/or execute one or more mitigation actions, and the like. Additionally or alternatively, internal entity computing device 120 may host or execute one or more applications, systems or the like for performing business functions, such as processing and storing transaction data, storing customer information, or the like. This data may, in some examples, be used to train one or more AI models.

External entity computing device 130 may be or include one or more computing devices (e.g., smart phones, wearable devices, tablet devices, laptop devices, desktop devices, or the like) that may be used by a threat actor to attempt to access various systems, data, or the like, of the enterprise organization. External entity computing device 130 may include user input devices that enable the threat actor to attempt to navigate through decoy data, file structures, and the like, generated by the decoy data generation computing platform 110, and a display configured to display decoy content.

As mentioned above, computing environment 100 also may include one or more networks, which may interconnect one or more of decoy data generation computing platform 110, internal entity computing device 120, and/or external entity computing device 130. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, decoy data generation computing platform 110, internal entity computing device 120, and/or external entity computing device 130 may be connected via network 190.

Referring to FIG. 1B, decoy data generation computing platform 110 may include one or more processors 111, memory 112, and communication interface 113. A data bus may interconnect processor(s) 111, memory 112, and communication interface 113. Communication interface 113 may be a network interface configured to support communication between decoy data generation computing platform 110 and one or more networks (e.g., network 190, or the like). Memory 112 may include one or more program modules having instructions that when executed by processor(s) 111 cause decoy data generation computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of decoy data generation computing platform 110 and/or by different computing devices that may form and/or otherwise make up decoy data generation computing platform 110.

For example, memory 112 may have, store and/or include threat actor detection module 112a. Threat actor detection module 112a may store instructions and/or data that may cause or enable the decoy data generation computing platform 110 to receive a request for access, data, or the like, and analyze the request to determine whether the user requesting the access or data, or device from which the request is received, is a threat actor or associated with a threat actor. In some examples, the determination may be based on characteristics of the device (e.g., internet protocol (IP) address, or like) that may be compared to a list of previous threat actors to detect a repeat threat actor. Additionally or alternatively, anomalies in behavior or data patterns may be detected that may indicate a threat actor. For instance, if credentials of a legitimate user are received from an unexpected location, at an unexpected time, or the like, the user may be identified as a threat actor and decoy data generation processes may be activated or initiated. Heuristic analysis may be used to detect abnormal requests for data that may be associated with a threat actor. In yet another example, the enterprise organization may have a safe list or allow list that identifies all legitimate users, devices associated with those users, and the like. Accordingly, any user or device that is not on the safe list or allow list may be considered a threat actor.

The examples for detecting a threat actor provided above are merely some examples. Various other arrangements for detecting threat actors may be used without departing from the invention.

Decoy data generation computing platform 110 may further have, store and/or include procedural generation engine 112b. Procedural generation engine 112b may store instructions and/or data that may cause or enable the decoy data generation computing platform 110 to dynamically generate file directories, structures, and/or database entries as a threat actor explores the system. For instance, upon detection of a threat actor, decoy data generation computing platform 110 may interact with the threat actor device (e.g., external entity computing device 130) to generate decoy data, provide the decoy data to the user, capture threat actor characteristics, and the like). Procedural generation engine 112b may continuously or near continuously (e.g., in real-time or near real-time as the threat actor is accessing the decoy system) generate realistic looking content (e.g., folders, files, and the like) that mimic the internal data structure of the enterprise organization. The content may be generated in real-time and may evolve based on the actions or selection of the threat actor (e.g., particular topics, files or directories selected by the threat actor may be input to the machine learning model to provide realistic decoy subdirectories, additional files, or the like. In some examples, algorithms such as Perlin Noise, L-System, or other content creation algorithms may be used to generate the file structure, files, and the like.

In some examples, procedural generation engine 112b may integrate with existing file systems at the kernel level to enable generation of procedural directories in real-time. This integration may permit the decoy data generation computing platform 110 to simulate legitimate file access, creation, and modification patterns. The procedural generation engine 112b may further be integrated into relational data management systems to enable the procedural generation engine 112b to generate decoy database entries in real-time and in response to a threat actor request, providing realistic but fake or decoy schemas and records.

Further, the procedural generation engine 112b may run in a background of decoy data generation computing platform 110 to ensure that as a threat actor explores a directory or file structure, new layers of decoy content may be dynamically created to prevent the threat actor from identifying the decoy and/or obtaining authentic data.

Decoy data generation computing platform 110 may further have, store and/or include artificial intelligence (AI)-driven file naming and data creation module 112c. AI-driven file naming and data creation module 112c may store instructions and/or data that may cause or enable the decoy data generation computing platform to host, train, execute, update and/or validate one or more generative AI models that may analyze typical file and database naming conventions of the enterprise organization to generate realistic decoy names and/or content structures. AI-driven file naming and data creation module 112c may dynamically adjust the decoy environment based on the behavior of the threat actor, generating plausible decoy file names, directory paths, and/or database schemas that mimic those found in the actual data of the enterprise organization. In some examples, the AI model(s) may be trained using historical business data and using one or more neural networks. The training data may include file naming conventions, directory structures, data organization patterns, and the like, associated with the enterprise organization. In some examples, the AI models may be trained using vast corpora of legitimate business data structures, including financial, legal, customer records, and the like. While this data will not be accessible to the threat actors, it may enable the AI model to generate realistic decoy data based on the training data.

The artificial intelligence used by AI-driven file naming and data creation module 112c may be integrated into or work in conjunction with procedural generation engine 112b to analyze patterns such as naming sequences, folder hierarchies, database field types, and the like, to provide realistic decoy data that may make it difficult for threat actors to detect the decoy data or distinguish between decoy data and authentic data. In some examples, AI-driven file naming and data creation module 112c may execute one or more generative AI models to evaluate a type of query, file access attempt, data exploration pattern, or the like, to ensure that each new decoy layer of files, data, or the like, is consistent with the context of previous actions and/or generated decoy data. In some examples, data related to threat actor selections (e.g., file name, content of file, file type, or the like) may be input to the generative AI model to output the decoy data.

In some examples, AI-driven file naming and data creation module 112c may execute one or more generative AI models to generate decoy data within files and databases, such as fabricated numbers, documents, and/or customer information that appears authentic but has no real-world value. For instance, content or other data information related to selections made by the threat actor may be input to the generative AI model in order to output the decoy content within the files, or the like. The AI-driven file naming and data creation module 112c may inject randomness into data access requests while maintaining the appearance of structured, authentic data.

Decoy data generation computing platform 110 may further have, store and/or include directory depth module 112d. Directory depth module 112d may store instructions and/or data that may cause or enable the decoy data generation computing platform 110 to execute one or more recursive algorithms to generate layers of directories and/or files. In some examples, each decoy directory created may lead to further decoy subdirectories generated in real-time, to provide the illusion, to the threat actor, of a large, complex data system that the threat actor is working through. In some examples, the depth of directories and the like may trap the threat actor in an endless loop, continuously generating more decoy layers of false directories and file structures to make it seem that the threat actor is accessing deeper areas of the system, while capturing data associated with the threat actor, device being used, and the like.

In some examples, the recursive generation algorithm used by the directory depth module 112d may be integrated with or tied directly into the file system event handling mechanism. Accordingly, each time an unauthorized user or threat actor attempts to enter a new directory or open a new file, the decoy data generation computing platform 110 may trigger the recursive function to create additional decoy subdirectories and file. Accordingly, the threat actor may consistently have new layers of decoy data to explore and the decoy data generation computing platform 110 may always remain ahead of the threat actor to ensure that no authentic data is accessed.

In some examples, directory depth module 112d, and/or other modules within the decoy data generation computing platform 110, may be configured to generate content at a rate proportional to the exploration speed of the threat actor. For example, if a threat actor moves quickly through directories, the decoy data generation computing platform 110 may scale up generation of decoy data to always remain one step ahead of the threat actor, generating as many subdirectories and/or files as needed to maintain the illusion of the endless or complex data structure. In some arrangements, in order to prevent excessive consumption of computing resources, the decoy data generation computing platform 110 may employ lazy loading techniques that generate directory structures only when accessed by a threat actor or unauthorized user. This may aid in ensuring that performance of the system for accessing actual data is not impacted by the decoy data generation.

Decoy data generation computing platform 110 may further have, store and/or include query response module 112c. Query response module 112e may store instructions and/or data that may cause or enable the decoy data generation computing platform 110 to intercept queries, such as SQL queries, made by a threat actor (e.g., during a database related attack) and generate plausible but fabricated decoy results or query responses. For instance, realistic looking decoy tables, records, data types and the like that mimic actual business operations of the enterprise organization, such as customer records, transaction records, product inventories, and the like, may be generated but contain no actual, authentic usable information. In some examples, a query interceptor may be used at the parsing layer to intercept the query and generate the decoy results. The decoy results may adhere to the database constraints and formats (e.g., valid data types, foreign key relationships, and the like) to make the decoy results appear authentic.

In some examples, the query response module 112e may integrate into the enterprise organization database management platform(s) at the query parsing layer. This may enable the query response module 112e to generate fabricated query results that may be substituted for legitimate query results, in real-time, to return decoy data that appears valid and relevant to the query. For instance, a request for customer information may return records containing fabricated or decoy names, addresses, transaction histories, and the like.

Further, the query response module 112e may ensure consistency across multiple queries. For instance, if a threat actor queries the same table multiple times or performs a JOIN between tables, the query response module 112e may ensure that the decoy data remains consistent across these operations, preventing detection of the decoy data by cross-referencing.

Decoy data generation computing platform 110 may further have, store and/or include database 112f. Database 112f may store data related to training one or more AI models, generated decoy data, threat actor characteristic data, and/or other data to perform the functions of decoy data generation computing platform 110.

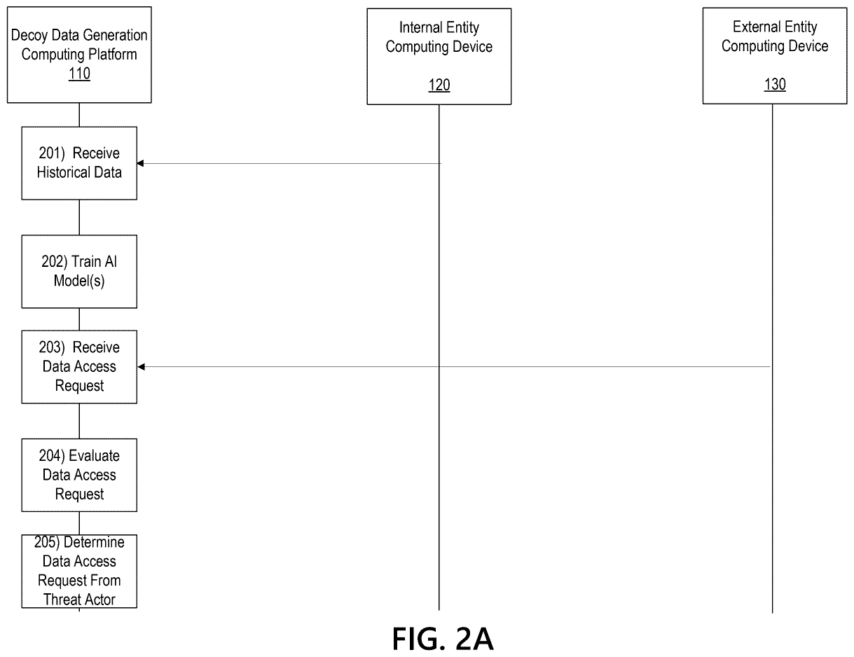

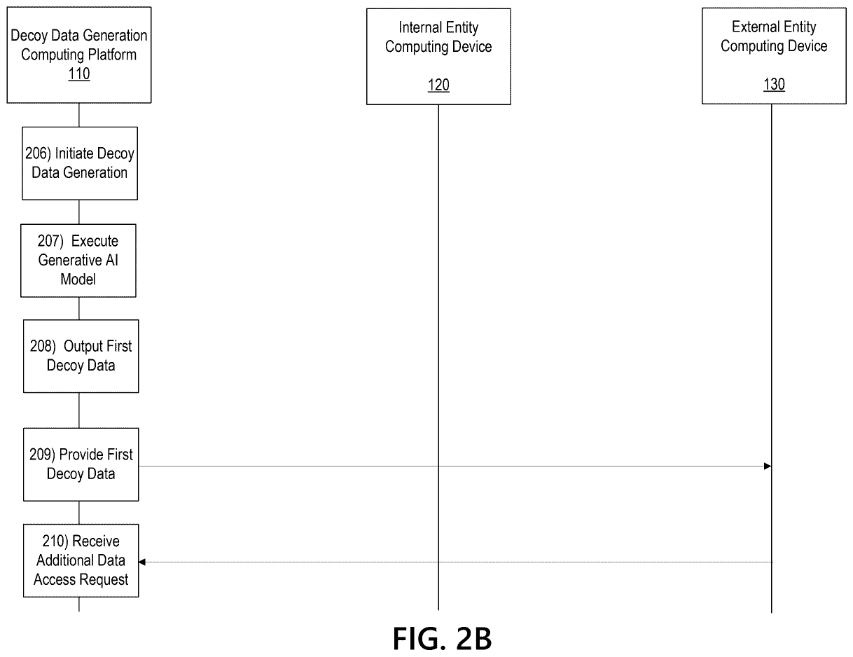

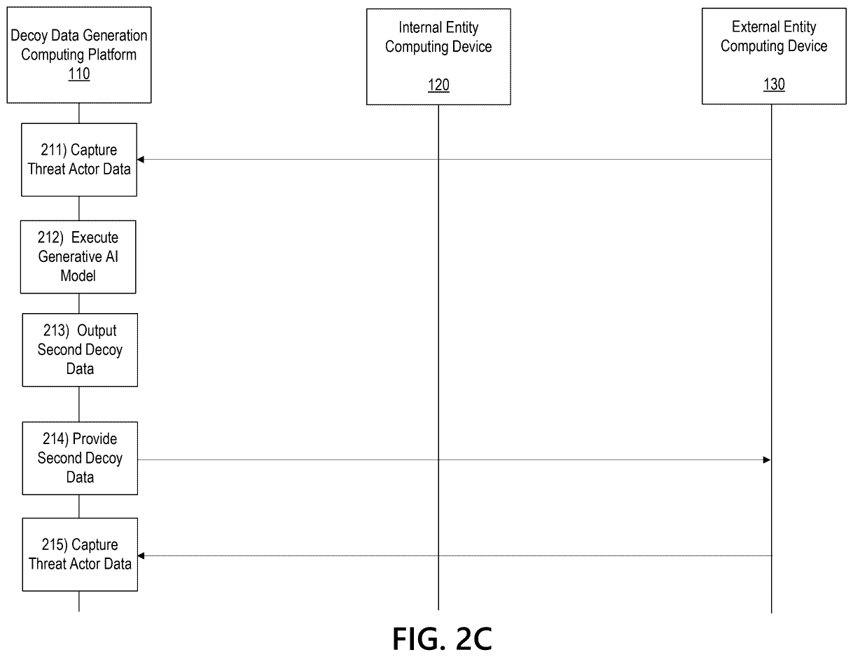

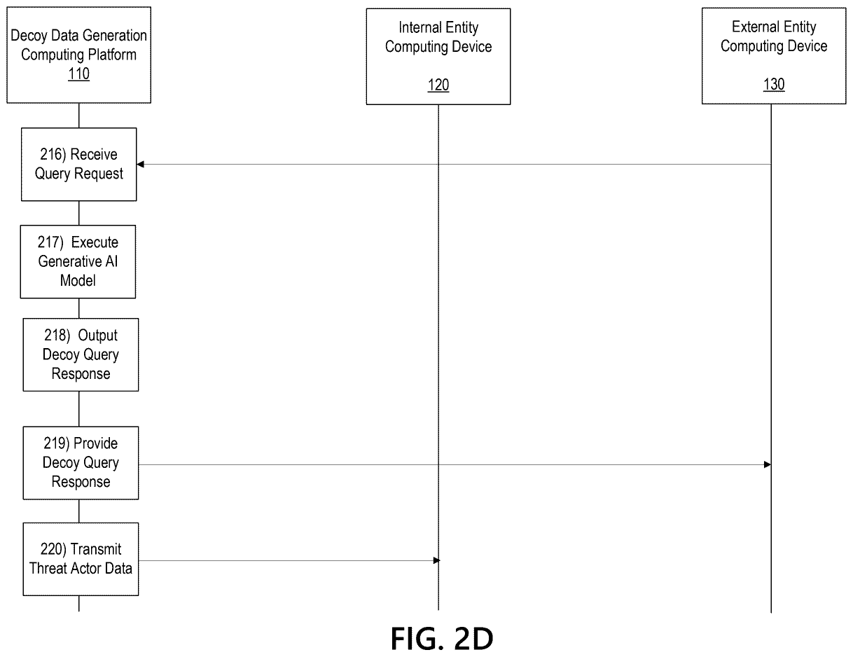

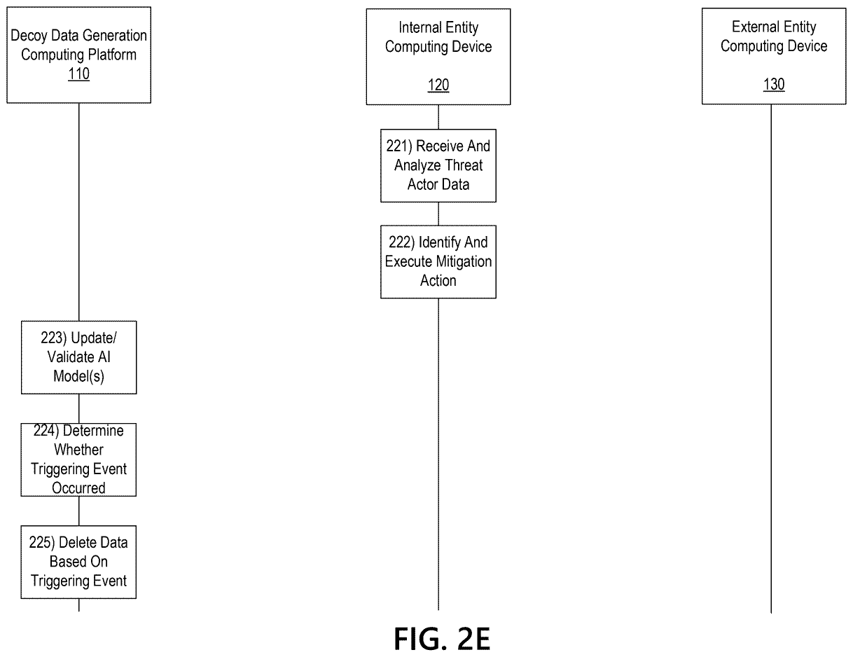

FIGS. 2A-2E depict one example illustrative event sequence for using machine learning to generate decoy data in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, decoy data generation computing platform 110 may receive historical data from one or more sources. For instance, internal entity computing device 120 may host or execute one or more systems, applications or the like for executing transactions, storing data, and the like. This data may be received by the decoy data generation computing platform 110 and used to train one or more machine learning models.

For instance, the historical data may be trained using one or more neural networks, or the like, to train the model to identify patterns, sequences, correlations, or the like, in data. For instance, the historical data may include file names, file structures or directories, customer data, and the like, that may be used to train the model to generate decoy data that is consistent with the enterprise organization naming conventions, file structures, content and the like.

At step 202, decoy data generation computing platform 110 may train one or more artificial intelligence models. For instance, a generative AI model may be trained, using the historical data, to receive subsequent data and output decoy data structures, directories, file names, content, query responses, or the like.

At step 203, decoy data generation computing platform 110 may receive a data access request from a computing device, such as external entity computing device 130. The data access request may include user credentials, an IP address or other device identifier, location of the device, a type of data or file being requested, or the like.

At step 204, decoy data generation computing platform 110 may evaluate the data in the data access request to determine whether a user associated with external entity computing device 130 is a threat actor or unauthorized user. For instance, data associated with the user or device may be compared to previously identified threat actor data, or third-party threat actor data, to determine that the user is a threat actor. Additionally or alternatively, the data associated with the request may be analyzed to determine whether it matches (e.g., within a predetermined threshold) expected data. For instance, if the credentials are authentic but the location from which the login request is received or the IP address do not match expected data, the user may be identified as a threat actor. In another example, if a time of the attempted login or data access request is outside of an expected time frame, the user may be identified as a threat actor. Various other methods of identifying threat actors may be used without departing from the invention.

At step 205, based on the analysis at step 204, the decoy data generation computing platform 110 may determine that the request is received from a threat actor.

With reference to FIG. 2B, in response to determining that the data access request is received from a threat actor, at step 206, decoy data generation computing platform 110 may activate or initiate decoy data generation processes (e.g., upon detecting a user selection from the threat actor or external entity computing device 130, decoy data generation computing platform 110 may, in real-time, generate decoy data to provide to the threat actor instead of authentic data).

At step 207, the generative AI model trained at step 202 may be executed. For instance, data from the data access request (e.g., a file name requested, a type of file requested, or the like) may be input to the model and the model may be executed to output first decoy data that includes one or more subsequent levels of data for selection (e.g., decoy additional files having similar content, decoy subdirectories, decoy file content, or the like). As discussed herein, the decoy data may be generated to mimic actual file structures, naming conventions, and the like, of the enterprise organization implementing the decoy data generation computing platform 110.

At step 208, decoy data generation computing platform 110 may output the generated first decoy data. At step 209, the generated first decoy data may be provided to the threat actor via external entity computing device 130. For instance, the external entity computing device 130 may be permitted to view, download, or the like, the first decoy data generated by the decoy data generation computing platform 110.

At step 210, decoy data generation computing platform 110 may receive a second or subsequent data access request from the external entity computing device 130. For instance, based on the first decoy data provided to the external entity computing device 130, the threat actor may request, select, or the like, additional data, file directories, content, or the like, for display, or the like. For instance, if the first decoy data included one or more subdirectories within a selected file structure, the threat actor may select one of the subdirectories and that selection may be transmitted to the decoy data generation computing platform 110 as a second or subsequent data access request.

With reference to FIG. 2C, at step 211, decoy data generation computing platform 110 may capture threat actor data as the first decoy data is presented to the threat actor, as selections or further exploration is performed (e.g., in response to the first decoy data) by the threat actor, and the like.

At step 212, decoy data generation computing platform 110 may execute the generative AI model using the second or subsequent data access request as inputs. For instance, the generative AI model may analyze the input data access request to output, at step 213, second decoy data generated based on the threat actor selections made in response to the first decoy data.

At step 214, the decoy data generation computing platform 110 may provide, to the threat actor via external entity computing device 130, the second decoy data. The second decoy data may include additional layers of file structure (e.g., additional decoy subdirectories, or the like), decoy file content, or the like.

The process may, in some examples, return to step 210 to receive additional subsequent data requests, analyze the requests using machine learning and generate additional decoy data outputs. In some examples, the process may continue as long as the threat actor is detected as accessing the system, giving the illusion of the threat actor accessing actual data while capturing data related to the threat actor.

At step 215, decoy data generation computing platform 110 may capture additional threat actor data based on the interaction with the second decoy data, additional selections made, or the like.

With reference to FIG. 2D, at step 216, decoy data generation computing platform 110 may receive a query request from the external entity computing device 130. In some examples, the query may be received in lieu of or in additional to one or more subsequent data access requests as described herein. The query may be intercepted by at the parsing layer and input to the generative AI model.

At step 217, the generative AI model may be executed using the query as inputs. At step 218, based on the execution of the model, decoy query response data may be output or generated by the generative AI model. The query response data may appear to be responsive to the query received from the threat actor but might include only decoy or fabricated data, rather than actual enterprise organization data.

At step 219, the decoy data generation computing platform 110 may provide the decoy query response data to the external entity computing device 130. In some examples, additional threat actor data may be captured based on threat actor interaction with the decoy query response data.

At step 220, decoy data generation computing platform 110 may transmit the captured threat actor data to an internal system or device for analysis, mitigation actions, or the like. For instance, decoy data generation computing platform 110 may transmit or send the captured threat actor data to internal entity computing device 120 for further analysis of the threat actor, storage of threat actor characteristics for use in future attacks, identification of one or more mitigation actions or execution of one or more countermeasures to prevent the threat actor, or other threat actors, from accessing the system.

With reference to FIG. 2E, at step 221, the internal entity computing device 120 may receive and analyze the threat actor data. In some examples, the threat actor data may be shared with one or more other parties (e.g., industry groups, other entities in similar areas, or the like).

At step 222, internal entity computing device 120 may identify and/or execute one or more mitigation actions, counter measures, or the like, based on the analysis of the threat actor data.

At step 223, decoy data generation computing platform 110 may update and/or validate the one or more AI models based on mitigation actions, threat actor data, or the like. Accordingly, feedback data may be provided to the models to continuously improve accuracy of the models.

At step 224, decoy data generation computing platform 110 may determine whether a triggering event has occurred for deleting the decoy data. For instance, in some examples, decoy data may be deleted upon a triggering event such as a threshold amount of data being reached, a time period for storage elapsing, or the like.

If a triggering event is detected, at step 225, some or all of the decoy data may be deleted. For instance, upon generation of the decoy data, metadata may be used to flag the decoy data as decoy data rather than authentic data. Accordingly, based on enterprise organization rules or preferences, upon detection of a triggering event, some or all of the decoy data may be deleted, compressed, or the like, based on the metadata flags associated with the data.

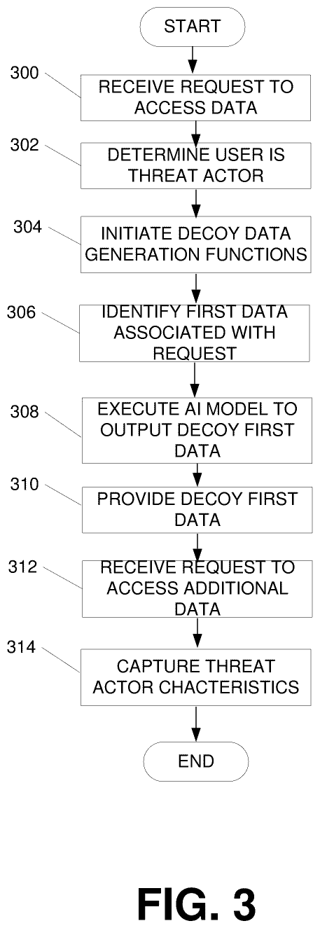

FIG. 3 is a flow chart illustrating one example method using machine learning to generate decoy data in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, decoy data generation computing platform 110 may receive a request to access data from a user device, such as external entity computing device 130.

At step 302, decoy data generation computing platform 110 may analyze the request to access data and the user device to determine whether the user device is associated with a threat actor. In some examples, features or characteristics of the user device may be compared to user devices associated with previous threat actors or attacks. Additionally or alternatively, the request to access data may be analyzed to determine whether it meets expected behavior patterns (e.g., expected location, expected time, or the like). Based on the analysis, the decoy data generation computing platform 110 may determine that the user device is associated with a threat actor.

At step 304, based on determining that the user device is associated with a threat actor, decoy data generation computing platform 110 may initiate one or more decoy data generation functions.

For instance, at step 306, decoy data generation computing platform 110 may identify first data associated with the request to access data. For instance, a file name, first directory, first content, or the like, may be identified from the request.

At step 308, decoy data generation computing platform 110 may execute, in real-time, a generative artificial intelligence model. In some examples, the first data associated with the request to access data may be input to the generative artificial intelligence model and, upon execution of the model, decoy first data may be output by the model. The decoy first data may be accessible to the threat actor. For instance, if the first data is a file name, the generative artificial intelligence model may output decoy content associated with the file name. In another example, if the first data is a first directory, the generative artificial intelligence model may output, as first decoy data, a plurality of decoy subdirectories.

At step 310, decoy data generation computing platform 110 may provide the decoy first data to the threat actor via the user device.

In response to providing the decoy first data, at step 312, decoy data generation computing platform 110 may receive, from the threat actor and via the user device, a request to access additional data. In some examples, the request to access additional data may include user input received by the user device and based on the decoy first data provided to the threat actor via the user device. For instance, if the first data is directory, the decoy first data may include a plurality of decoy subdirectories and the request for additional data may include user input from the threat actor selecting one of the decoy subdirectories.

At step 314, decoy data generation computing platform 110 may capture, in real-time, threat actor characteristics based on the request to access data, request to access additional data and/or interactions between the user device associated with the threat actor and the decoy data generation computing platform 110. This data may then be used to deploy countermeasures or identify and execute one or more mitigation actions.

As discussed herein, as the threat actor continues to explore what they think is authentic data but is decoy data generated by the decoy data generation computing platform 110, additional requests for data may be received from the threat actor which may prompt or trigger the decoy data generation computing platform 110 to generate additional decoy data (e.g., using the generative artificial intelligence model as discussed herein). Accordingly, for instance, the generative artificial intelligence model may receive, as inputs, the request to access additional data, or subsequent data requests, and output decoy second or subsequent data that may be provided to the threat actor via the user device.

As also discussed, a threat actor may provide a database query to the decoy data generation computing platform 110. The database query may be intercepted at the parsing layer and decoy database query response data generated by the generative artificial intelligence model may be generated and provided to the threat actor via the user device.

As discussed herein, the arrangements described provide for dynamic and continuous lures for threat actors. As the threat actor continues to explore files, directories, databases, and the like, the system may continue to generate decoy data that the threat actor may think is authentic but, in fact, includes no actual usable data. This arrangement may also enable the enterprise organization implementing the system to capture data related to the threat actor in order to develop and deploy countermeasures to avoid future attacks. The threat actor may think that they are access data within the enterprise organization but instead, are viewing decoy data.

As discussed, the arrangements described including using generative artificial intelligence models to generate the decoy data in real-time. The models may be trained using historical data of the enterprise organization including naming conventions, file structures, and the like. Accordingly, as the model generates decoy data, the data may be particular to or consistent with real or authentic enterprise organization data because the model has been trained using that data. This may provide realistic decoy results that will seem authentic to the threat actor.

As discussed, the real-time generation of decoy data may encourage the threat actor to remain within the system, exploring various files, directories and the like. During this time, the decoy data generation computing platform 110 may capture data related to the threat actor, that may be used to combat future attacks, may be shared with other organizations or industry groups, or the like. For instance, data such as behavior patterns of the threat actors, tactics, origin, logs, search and access techniques, digital fingerprint, command and query data, devices, metrics of interactions, tool signatures and payloads, methods, and the like, may be captured from the threat actors. This data may be used to develop and/or deploy countermeasures to avoid future attacks, execute mitigation actions to avoid impact from attacks, and the like. The data captured may be useful in understanding techniques being used by threat actors, as well as types of data being accessed.

Further, in some examples, the decoy data may be encrypted. For instance, authentic data being accessed by a threat actor in a conventional system may be encrypted. Accordingly, in some arrangements, the decoy data may also be encrypted to further give the appearance that the decoy data is actual, authentic enterprise organization data.

As discussed herein, in some examples, some or all of the generated decoy data may be deleted, compressed, or the like, to avoid storing vast amount of decoy data for extended periods. In some examples, upon detection of a triggering event, such as a predetermined amount of time from the date of creation lapsing, a threshold amount of data being generated, a detection of an off-peak time period, or the like, the decoy data may be flagged for repurposing, deleted, compressed, or the like. In some examples, the decoy data, upon generation, may include metadata flagging the decoy data as noise or decoy data. Accordingly, a controlled purge of decoy data upon detection of a triggering event may efficiently be performed without concern for deletion of actual, authentic data. The deletion of decoy data may also be performed on a manual basis.

The arrangements described may also be scalable based on a size of the enterprise organization. For instance, larger enterprise organizations may have more resources to store decoy data, threat actor data, or the like, for longer periods of time. Accordingly, the system may be customized to control data deletion based on the resources available for that organization. If a smaller organization is implementing the arrangements described herein, they may have fewer resources and may more frequently delete decoy data in order to avoid consuming storage resources.

In some examples, portions of the decoy data, threat actor data, or the like, may be stored for an extended period to enable further analysis of the data and threat actor. In some examples, the data may be used to update, validate, retrain, or the like, the one or more models. Accordingly, a repeat threat actor may be quickly identified and some decoy data may, in some examples, be reused for that repeat hacker.

Further, because the decoy data is flagged as decoy data, the system may easily access only authentic data when performing functions in the course of business. For instance, the decoy data, while possibly including data that, if authentic, would result in an alert or notification, might not trigger an alert or notification because it is flagged as decoy data. Accordingly, this may aid in reducing or eliminating issues identified for the decoy data.

Further, as discussed, the data generated and captured may be used to develop, deploy or the like, countermeasures or other mitigation actions. Accordingly, the system may be integrated with one or more other systems within the enterprise organization to efficiently develop, identify and deploy actions to mitigate risk and avoid future attempts to access the system.

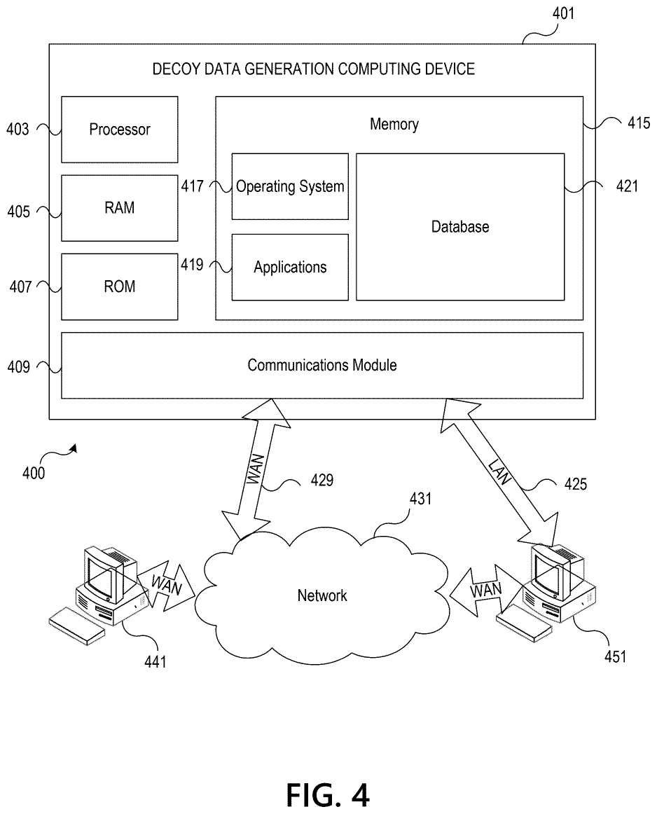

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include decoy data generation computing device 401 having processor 403 for controlling overall operation of decoy data generation computing device 401 and its associated components, including Random Access Memory (RAM) 405, Read-Only Memory (ROM) 407, communications module 409, and memory 415. Decoy data generation computing device 401 may include a variety of computer readable media. Computer readable media may be any available media that may be accessed by decoy data generation computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by decoy data generation computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on decoy data generation computing device 401. Such a processor may execute computer-executable instructions stored on a computer-readable medium.

Software may be stored within memory 415 and/or storage to provide instructions to processor 403 for enabling decoy data generation computing device 401 to perform various functions as discussed herein. For example, memory 415 may store software used by decoy data generation computing device 401, such as operating system 417, application programs 419, and associated database 421. Also, some or all of the computer executable instructions for decoy data generation computing device 401 may be embodied in hardware or firmware. Although not shown, RAM 405 may include one or more applications representing the application data stored in RAM 405 while decoy data generation computing device 401 is on and corresponding software applications (e.g., software tasks) are running on decoy data generation computing device 401.

Communications module 409 may include a microphone, keypad, touch screen, and/or stylus through which a user of decoy data generation computing device 401 may provide input, and may also include one or more of a speaker for providing audio output and a video display device for providing textual, audiovisual and/or graphical output. Computing system environment 400 may also include optical scanners (not shown).

Decoy data generation computing device 401 may operate in a networked environment supporting connections to one or more remote computing devices, such as computing devices 441 and 451. Computing devices 441 and 451 may be personal computing devices or servers that include any or all of the elements described above relative to decoy data generation computing device 401.

The network connections depicted in FIG. 4 may include Local Area Network (LAN) 425 and Wide Area Network (WAN) 429, as well as other networks. When used in a LAN networking environment, decoy data generation computing device 401 may be connected to LAN 425 through a network interface or adapter in communications module 409. When used in a WAN networking environment, decoy data generation computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive a request to access data from a user device;
determine, based on the request to access data, that the user device is associated with a threat actor;
initiate, based on determining that the user device is associated with a threat actor, decoy data generation functions, wherein the decoy data generation functions include:
identify first data associated with the request to access data;
execute, in real-time, a generative artificial intelligence model, wherein executing the generative artificial intelligence model includes inputting, to the generative artificial intelligence model, the first data to output, in real-time, decoy first data accessible to the threat actor;
provide, to the threat actor via the user device, the decoy first data;
receive, from the threat actor and via the user device, a request to access additional data, wherein the request to access the additional data includes user input received based on the decoy first data provided to the threat actor via the user device; and
capture, in real-time, threat actor characteristics based on the request to access data, request to access additional data and interactions between the user device associated with the threat actor and the computing platform.

2. The computing platform of claim 1, further including instructions that, when executed, cause the computing platform to:
execute, in real-time, the generative artificial intelligence model, wherein executing the generative artificial intelligence model includes inputting, to the generative artificial intelligence model, the request to access additional data to output, in real-time, decoy second data accessible to the threat actor; and
provide, to the threat actor via the user device, the decoy second data.

3. The computing platform of claim 1, wherein the first data associated with the request to access data includes a file name and the decoy first data includes decoy content associated with the file name.

4. The computing platform of claim 1, wherein the first data associated with the request to access data includes a first directory within a data structure and the decoy first data includes a plurality of decoy subdirectories for selection within the first directory.

5. The computing platform of claim 1, further including instructions that, when executed, cause the computing platform to:
receive, from the threat actor and via the user device, a database query;
intercept the database query at a parsing layer;
execute, in real-time, the generative artificial intelligence model, wherein executing the generative artificial intelligence model includes inputting, to the generative artificial intelligence model, the database query to output, in real-time, decoy database query response data; and
provide, to the threat actor via the user device, the decoy database query response data.

6. The computing platform of claim 5, wherein the decoy database query response data includes decoy tables.

7. The computing platform of claim 1, further including instructions that, when executed, cause the computing platform to:
train, using historical file data of an enterprise organization, the generative artificial intelligence model.

8. The computing platform of claim 7, wherein the decoy first data and decoy second data are consistent with aspects of data associated with the enterprise organization based on the training the generative artificial intelligence model.

9. A method, comprising:
receiving, by a computing platform, the computing platform having at least one processor, and memory, a request to access data from a user device;
determining, by the at least one processor and based on the request to access data, that the user device is associated with a threat actor;
initiating, by the at least one processor and based on determining that the user device is associated with a threat actor, decoy data generation functions, wherein the decoy data generation functions include:
identifying, by the at least one processor, first data associated with the request to access data;
executing, by the at least one processor and in real-time, a generative artificial intelligence model, wherein executing the generative artificial intelligence model includes inputting, to the generative artificial intelligence model, the first data to output, in real-time, decoy first data accessible to the threat actor;
providing, by the at least one processor to the threat actor via the user device, the decoy first data;
receiving, by the at least one processor and from the threat actor and via the user device, a request to access additional data, wherein the request to access the additional data includes user input received based on the decoy first data provided to the threat actor via the user device; and
capturing, by the at least one processor and in real-time, threat actor characteristics based on the request to access data, request to access additional data and interactions between the user device associated with the threat actor and the computing platform.

10. The method of claim 9, further including:
executing, by the at least one processor and in real-time, the generative artificial intelligence model, wherein executing the generative artificial intelligence model includes inputting, to the generative artificial intelligence model, the request to access additional data to output, in real-time, decoy second data accessible to the threat actor; and
providing, by the at least one processor and to the threat actor via the user device, the decoy second data.

11. The method of claim 9, wherein the first data associated with the request to access data includes a file name and the decoy first data includes decoy content associated with the file name.

12. The method of claim 9, wherein the first data associated with the request to access data includes a first directory within a data structure and the decoy first data includes a plurality of decoy subdirectories for selection within the first directory.

13. The method of claim 9, further including:
receiving, by the at least one processor and from the threat actor and via the user device, a database query;
intercepting, by the at least one processor, the database query at a parsing layer;
executing, by the at least one processor and in real-time, the generative artificial intelligence model, wherein executing the generative artificial intelligence model includes inputting, to the generative artificial intelligence model, the database query to output, in real-time, decoy database query response data; and
providing, by the at least one processor and to the threat actor via the user device, the decoy database query response data.

14. The method of claim 13, wherein the decoy database query response data includes decoy tables.

15. The method of claim 9, further including:
training, by the at least one processor and using historical file data of an enterprise organization, the generative artificial intelligence model.

16. The method of claim 15, wherein the decoy first data and decoy second data are consistent with aspects of data associated with the enterprise organization based on the training the generative artificial intelligence model.

17. One or more non-transitory computer-readable media storing instructions that, when executed by a computing platform comprising at least one processor, memory, and a communication interface, cause the computing platform to:
receive a request to access data from a user device;
determine, based on the request to access data, that the user device is associated with a threat actor;
initiate, based on determining that the user device is associated with a threat actor, decoy data generation functions, wherein the decoy data generation functions include:
identify first data associated with the request to access data;
execute, in real-time, a generative artificial intelligence model, wherein executing the generative artificial intelligence model includes inputting, to the generative artificial intelligence model, the first data to output, in real-time, decoy first data accessible to the threat actor;
provide, to the threat actor via the user device, the decoy first data;
receive, from the threat actor and via the user device, a request to access additional data, wherein the request to access the additional data includes user input received based on the decoy first data provided to the threat actor via the user device; and
capture, in real-time, threat actor characteristics based on the request to access data, request to access additional data and interactions between the user device associated with the threat actor and the computing platform.

18. The one or more non-transitory computer-readable media of claim 17, further including instructions that, when executed, cause the computing platform to:
execute, in real-time, the generative artificial intelligence model, wherein executing the generative artificial intelligence model includes inputting, to the generative artificial intelligence model, the request to access additional data to output, in real-time, decoy second data accessible to the threat actor; and
provide, to the threat actor via the user device, the decoy second data.

19. The one or more non-transitory computer-readable media of claim 17, further including instructions that, when executed, cause the computing platform to:
receive, from the threat actor and via the user device, a database query;
intercept the database query at a parsing layer;
execute, in real-time, the generative artificial intelligence model, wherein executing the generative artificial intelligence model includes inputting, to the generative artificial intelligence model, the database query to output, in real-time, decoy database query response data; and
provide, to the threat actor via the user device, the decoy database query response data.

20. The one or more non-transitory computer-readable media of claim 17, further including instructions that, when executed, cause the computing platform to:
train, using historical file data of an enterprise organization, the generative artificial intelligence model.
